(19) United States
(12) Patent Application Publication
(10) Pub. No.: US 2012/0025708 A1
(43) Pub. Date: Feb. 2, 2012

(54) LIGHT EMITTING DIODE BULB USING THERMAL CONDUCTOR

(76) Inventors: Woo Sun CHOI, Gyeonggi-do (KR); Ho Seop PARK, Gyeonggi-do (KR)

(21) Appl. No.: 13/104,731

(22) Filed: May 10, 2011

(30) Foreign Application Priority Data
Jul. 29, 2010 (KR) 10-2010-0073128
Oct. 18, 2010 (KR) 10-2010-0101486

(51) Int. Cl. H01J 13/46

(52) U.S. Cl. 315/35

(57) ABSTRACT

An LED bulb using a thermal conductor. The LED bulb includes an LED module having a PCB on which at least one LED element is mounted. A housing has a plurality of heat dissipating protrusions which protrude from an outer circumferential surface thereof, and is made of a thermal conductor, with a thread being formed on a predetermined portion of the housing. A light transmitting cover has a thread by which the cover can be fastened to the thread which is formed on the predetermined portion of the housing, in a threaded manner. An inverter supplies a direct current to the LED module. A heat dissipating plate is provided between the LED module and the housing to dissipate heat generated by the LED element. A socket is fastened to the housing.

### CROSS-REFERENCE TO RELATED APPLICATIONS

This application claims priority under 35 U.S.C. §119 to Korean Patent Application No. 10-2010-0073218, filed on Jul. 29, 2010 and Korean Patent Application No. 10-2010-0101486, filed Oct. 18, 2010, in the Korean Intellectual Property Office, the disclosures of which are incorporated herein by reference in their entireties.

### BACKGROUND OF THE INVENTION

1. Technical Field

The present invention relates generally to an LED bulb using a thermal conductor and, more particularly, to an LED bulb using a thermal conductor, in which a housing is formed using a thermal conductor, and a heat dissipating plate is integrated with the housing by conducting insert injection molding, so that the LED bulb is capable of easily dissipating heat that is generated by an LED element.

2. Background Art

Recently, lighting apparatuses that use a light emitting diode (hereinafter, referred to as an LED) to substitute for a fluorescent light have been subject to active development. The LED is advantageous in that the efficiency with which power is converted into light is excellent, the efficiency of light per unit power is high, its life span is long, power consumption is low, and high luminous intensity is obtained. Such LEDs have been used for a variety of purposes.

LED lights are advantageous because the processing speed is high and power consumption is low, whereas LED lights are disadvantageous because the light emitting part comprises a semiconductor element, so that it is more vulnerable to heat than are incandescent bulbs or fluorescent lights. That is, since LED lights are constructed so that a plurality of LED elements is mounted on an LED module, the amount of heat that is generated is large.

A conventional LED bulb mainly includes a light transmitting cover, a housing, a bottom case into which an inverter is inserted, and a socket. The conventional LED bulb connects the inverter connected to the socket with an LED module having an LED element thereon via wires so as to supply power to the LED element. Especially, when the LED bulb is produced, the socket, the bottom case, the housing, and the light transmitting cover must be integrally fastened to and assembled with each other. However, an increase in the number of assembling processes unnecessarily consumes assembling labor, managing labor, and material costs.

Especially, the conventional LED bulb is problematic in that the surface area of the housing is relatively small, and an additional heat dissipating structure is not provided, so that it is difficult to effectively dissipate heat emitted from the LED element. Hence, it is impossible to supply a predetermined or more of electric current to the LED element, so that a relatively large number of LED modules are required to use the LED element as a lighting apparatus.

Further, in the case of applying a cooling method to the LED bulb, there is a limitation in dissipating heat which is generated when the LED element is driven. In order to overcome the problem, the size of a heat dissipating member may be increased. This causes the size, weight, and cost of a product to increase, so that it is difficult to satisfy consumers.

### DISCLOSURE OF THE INVENTION

### Technical Problem

Accordingly, the present invention has been made keeping in mind the above problems occurring in the prior art, and an object of the present invention is to provide an LED bulb using a thermal conductor, which is constructed so that a heat dissipating plate is integrated with a housing by insert injection molding.

Another object of the present invention is to provide an LED bulb using a thermal conductor, which does not require a bottom case into which an inverter is inserted, by using a connector fastened to the inverter.

A further object of the present invention is to provide an LED bulb using a thermal conductor, which is constructed so that a plurality of heat dissipating protrusions protrudes from an outer circumferential surface of a housing that is formed using a thermal conductor, thus increasing the surface area of the housing, therefore effectively dissipating the heat generated by an LED element.

Yet another object of the present invention is to provide an LED bulb using a thermal conductor, in which a housing and a light transmitting cover are constructed to be fastened to each other in a rotary locking manner, thus allowing the housing and the light transmitting cover to be fastened to each other in a simple manner.

### Technical Solution

In order to accomplish the above objects, the present invention provides an LED bulb using a thermal conductor, including an LED module having a PCB on which at least one LED element is mounted, a housing having a plurality of heat dissipating protrusions which protrude from an outer circumferential surface thereof, and made of a thermal conductor, with a thread being formed on a predetermined portion of the housing, a light transmitting cover having a thread by which the cover can be fastened to the thread which is formed on the predetermined portion of the housing, in a threaded manner, an inverter supplying a direct current to the LED module, a heat dissipating plate provided between the LED module and the housing to dissipate heat generated by the LED element, and a socket fastened to the housing.

Further, the heat dissipating plate may be integrated with the housing by insert injection when the housing is formed.

The heat dissipating plate may further include a heat dissipating part which is provided on a lower portion of the heat dissipating plate that faces the housing, and has at least one of a wavy shape and an uneven shape.

Further, the heat dissipating plate may be made of a material having heat conductivity.

The LED bulb may further include a connector coupled to the inverter by a one-touch-type coupling manner.

Further, the plurality of heat dissipating protrusions may be radially arranged on the outer circumferential surface of the housing in such a way as to protrude in a direction perpendicular to an axial direction of the housing.

Further, each of the heat dissipating protrusions may be tapered such that an area thereof increases in a direction from a lower portion to an upper portion of the housing.

Further, the inverter may be connected to the socket via an electrode wire, and may convert an alternating current, input from an outside through the socket, into a direct current and then supply the direct current to the LED module.

Furthermore, the housing may be formed using a thermal conductive resin including thermal conductive plastics.

### Advantageous Effects

Therefore, the present invention provides an LED bulb using a thermal conductor, which is constructed so that a heat dissipating plate is integrated with a housing by insert injection molding, thus allowing heat generated by an LED element to be easily dissipated.

Further, the present invention provides an LED bulb using a thermal conductor, which does not require a bottom case into which an inverter is inserted, by using a connector fastened to the inverter, thus reducing the number of the assembling processes of the LED bulb, the assembling and managing labor, and material costs.

Furthermore, the present invention provides an LED bulb using a thermal conductor, which is constructed so that a plurality of heat dissipating protrusions protrudes from an outer circumferential surface of a housing that is formed using a thermal conductor, thus increasing the surface area of the housing, therefore effectively dissipating the heat generated by an LED element, and the housing is formed using a light thermal conductor, thus reducing the weight of the LED bulb.

Further, the present invention provides an LED bulb using a thermal conductor, in which a housing and a light transmitting cover are constructed to be fastened to each other in a rotary locking manner, thus allowing the housing and the light transmitting cover to be fastened to each other in a simple manner.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing an LED bulb using a thermal conductor according to an embodiment of the present invention;

FIG. 2 is a front view showing the LED bulb using the thermal conductor according to the embodiment of the present invention;

FIG. 3 is a sectional view showing the LED bulb using the thermal conductor according to the embodiment of the present invention;

FIG. 4 is an enlarged view illustrating a heat dissipating plate of FIG. 3;

FIG. 5 is an enlarged view illustrating another embodiment of the heat dissipating plate of FIG. 3;

FIG. 6 is an enlarged view illustrating a further embodiment of the heat dissipating plate of FIG. 3;

FIG. 7 is an enlarged view illustrating a connector and inverter fastening structure of FIG. 3; and

FIG. 8 is an exploded perspective view showing the LED bulb using the thermal conductor according to the embodiment of the present invention.

### MODE FOR INVENTION

Hereinafter, the preferred embodiment of the present invention will be described in detail with reference to the accompanying drawings. The terminology or words used in the description and the claims of the present invention should not be interpreted as being limited merely to common or dictionary meanings. On the contrary, they should be interpreted based on the meanings and concepts of the invention in keeping with the scope of the invention on the basis of the principle that the inventor(s) can appropriately define the terms in order to most clearly describe the invention.

Therefore, it is to be understood by those skilled in the art that the form of the invention herein shown and described is to be taken as a preferred embodiment of the present invention and does not cover all spirits of the present invention and that all changes which fall within the meets and bounds of the claims, or the equivalence of such meets and bounds are intended to be embraced by the claims.

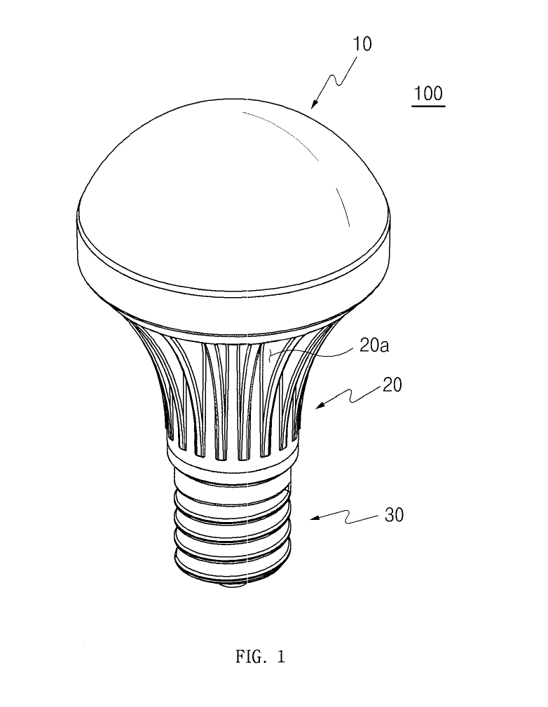

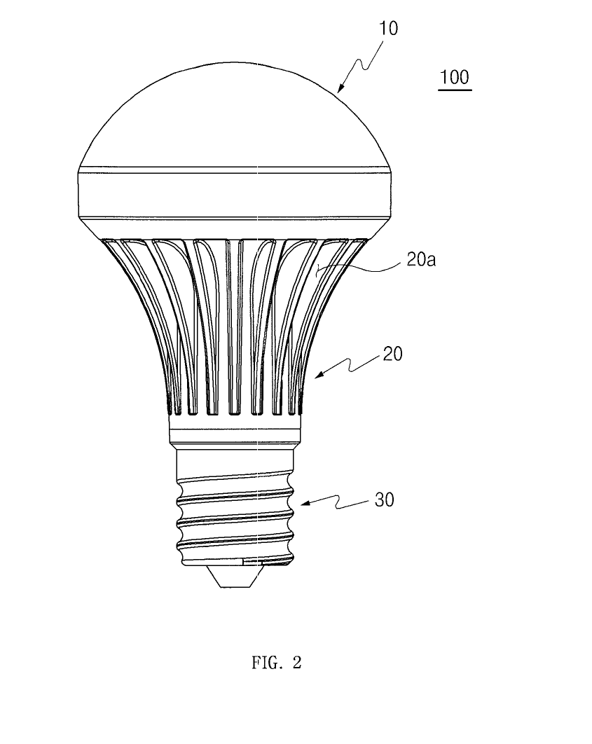

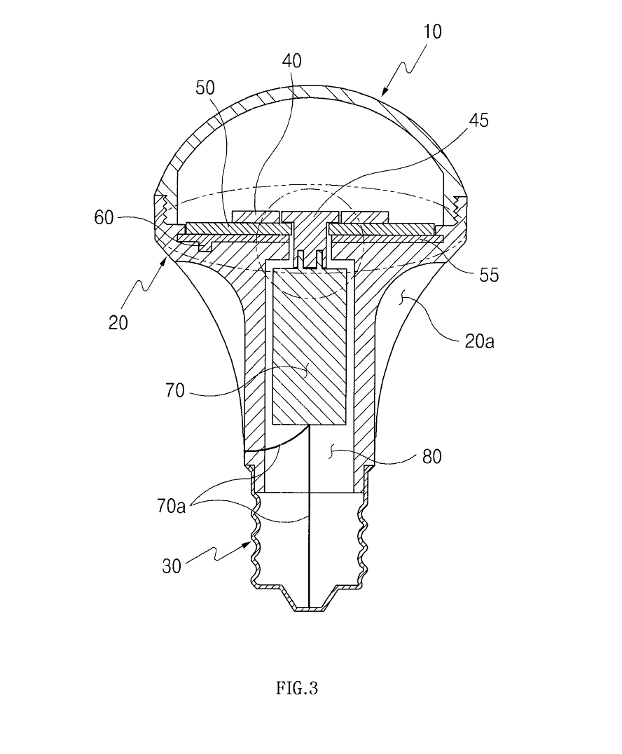

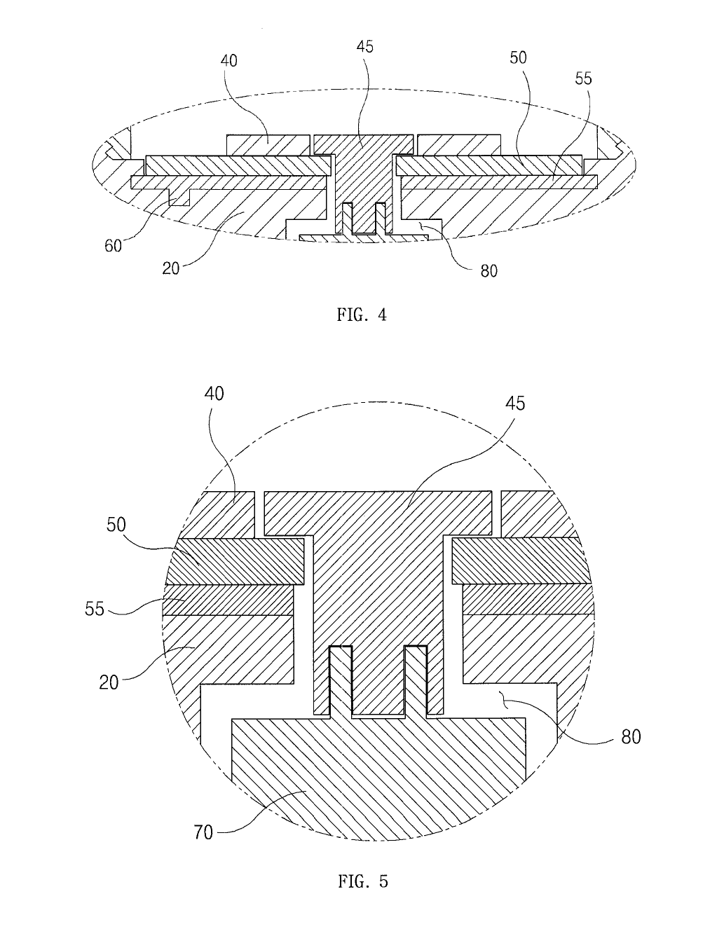

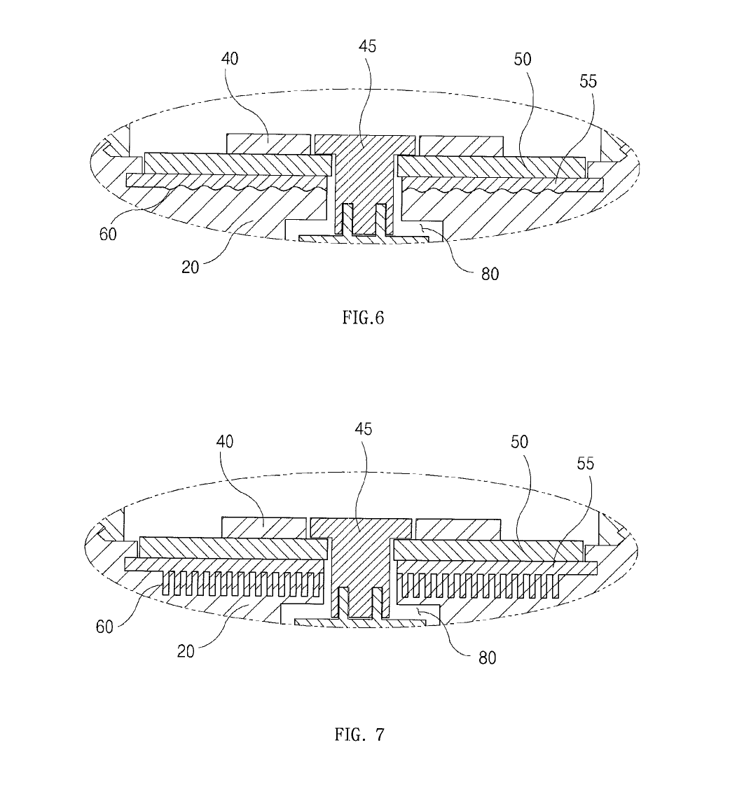

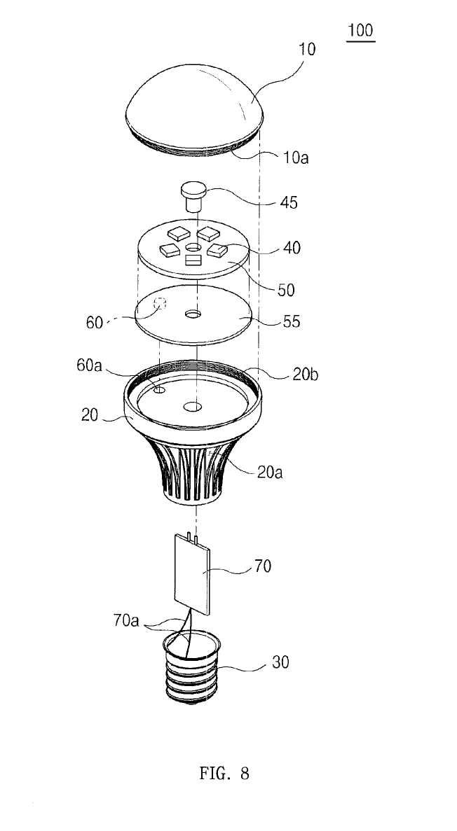

FIG. 1 is a perspective view showing an LED bulb using a thermal conductor according to an embodiment of the present invention. FIG. 2 is a front view showing the LED bulb using the thermal conductor according to the embodiment of the present invention. FIG. 3 is a sectional view showing the LED bulb using the thermal conductor according to the embodiment of the present invention. FIG. 4 is an enlarged view illustrating a heat dissipating plate of FIG. 3. FIG. 5 is an enlarged view illustrating another embodiment of the heat dissipating plate of FIG. 3. FIG. 6 is an enlarged view illustrating a further embodiment of the heat dissipating plate of FIG. 3. FIG. 7 is an enlarged view illustrating a connector and inverter fastening structure of FIG. 3. FIG. 8 is an exploded perspective view showing the LED bulb using the thermal conductor according to the embodiment of the present invention.

Referring to FIGS. 1 to 8, an LED bulb 100 using a thermal conductor of the present invention includes a light transmitting cover 10, a housing 20, and a socket 30.

The hemispherical light transmitting cover 10 and the housing 20 are fastened to each other in a rotary locking manner, namely, a threaded manner. To this end, threads 10a and 20b are formed, respectively, on predetermined portions of the light transmitting cover 10 and the housing 20 so that they are fastened to each other in a threaded manner. Thus, the light transmitting cover 10 and the housing 20 can be simply fastened to each other.

According to this embodiment, the light transmitting cover 10 has a hemispherical shape, but is not limited to the hemispherical shape. As long as only the area of the light transmitting cover 10 having the thread 10a to be fastened to the housing 20 has a circular shape, the light transmitting cover 10 may have any shape.

An LED module 50 is adhered to the housing 20 in such a way as to face the light transmitting cover 10, and includes a PCB on which a plurality of LED elements 40 is mounted.

The housing 20 includes a plurality of heat dissipating protrusions 20a which protrude from the outer circumferential surface of the housing 20. The heat dissipating protrusions 20a protrude from the outer circumferential surface of the housing 20 in a direction perpendicular to an axial direction, and are radially arranged. Here, the heat dissipating protrusions 20a may protrude integrally from the outer circumferential surface of the housing 20.

Further, each heat dissipating protrusion 20a is tapered such that its area increases in a direction from a lower portion to an upper portion of the housing 20. In detail, the heat dissipating protrusion 20a is shaped such that its area is gradually increased in a direction from the lower portion of the housing 20, that is, a position adjacent to the socket 30, through a position adjacent to the middle portion of the housing 20, to the upper portion of the housing 20, that is, a position adjacent to the LED module 50.

The LED bulb 100 includes the plurality of heat dissipating protrusions 20a on the housing 20, thus enlarging the surface area of the housing 20. Especially, since the area of each heat dissipating protrusion 20a is increased towards a surface of the housing 20 to which the LED module 50 is adhered, namely, towards the upper portion of the housing 20, heat generated from the LED elements 40 can be dissipated as quickly as possible.

A step, which corresponds to the extent to which the heat dissipating protrusions 20a protrude, is formed on the housing 20. The housing 20 itself is made of a thermal conductor resin such as a plastic, thus reducing the weight of the LED bulb 100, and lowering the temperature of heat generated by the housing 20.

When the housing 20 is formed by injection molding after inserting a plate made of a thermal conductive material, such as aluminum, a heat dissipating plate 55 is integrated with the housing 20 in such a way as to be in contact with a surface of the housing 20.

Further, the LED module 50 makes contact with a PCB on which the plurality of LED elements 40 is mounted and is furthermore assembled with the heat dissipating plate 55 which is formed in the housing 20 by insert injection.

Insert injection is a method of integrating different kinds or colors of plastics with each other or integrating plastics with parts (metal, electric wires, magnets, etc.) other than the plastics in a mold. This method provides a molded product having characteristics which are difficult to be achieved exclusively by the use of plastics.

The molded product is shown in FIGS. 4 to 6. The heat dissipating plate 55 formed in the housing 20 by insert injection includes a heat dissipating part 60, and the housing 20 has a fastening hole 60a so that the heat dissipating part 60 is inserted into the fastening hole 60a.

If the heat dissipating part 60 is formed as shown in FIG. 4, heat dissipating parts 60 may be located, respectively, at positions where the heat dissipating plate 55 is trisected, and besides, fastening holes 60a may be preferably formed to correspond to the heat dissipating parts 60.

Further, if the heat dissipating part 60 has a wavy shape as shown in FIG. 5, the housing 20 facing the heat dissipating part 60 also has a wavy shape to correspond to the wavy heat dissipating part formed on the heat dissipating plate 55, so that the heat dissipating part 60 may be fastened to the housing 20.

Furthermore, if the heat dissipating part 60 has an uneven shape as shown in FIG. 6, the housing 20 facing the heat dissipating part 60 also has an uneven shape that corresponds to the uneven shape of the heat dissipating part 60 formed on the heat dissipating plate 55, so that the heat dissipating part 60 may be fastened to the housing 20.

When the heat dissipating plate 55 is formed as shown in FIG. 5 or 6, the surface area of the heat dissipating part 60 is enlarged, thus allowing heat generated by the LED elements 40 to be more effectively dissipated.

The following table 1 shows the results of performing experiments on the LED bulb 100 according to the present invention. Here, the LED bulb described as an “aluminum housing” means an LED bulb that does not have the heat dissipating plate which is manufactured by insert injection molding. Meanwhile, the LED bulb described as a “heat dissipating plate (1 mm)” means an LED bulb having a heat dissipating plate which is manufactured by insert injection molding and has the thickness of 1 mm.

TABLE 1

| | | | Average | | Maximum |
|---|---|---|---|---|---|
| | | External | Temperature of | | Temperature |
| | Heat | Average | Heat | Maximum | of Heat |
| | Conductivity | Temperature | Dissipating | Temperature | Dissipating |
| | (W/m-K) | of Housing | Plate Surface | of Housing | Plate |
| Aluminum | 8.1 | 45.4(° C.) | — | 45.6(° C.) | — |
| Housing | | | | | |
| Heat | 8.1 | 54.9(° C.) | 61.7(° C.) | 61.7(° C.) | 61.9(° C.) |
| Dissipat- | | | | | |
| ing Plate | | | | | |
| (1 mm) | | | | | |

As seen in table 1, the conventional LED bulb having the aluminum housing has a heat conductivity of 8.1 when the external average temperature of the housing and the maximum temperature of the housing are 45.4° C. and 45.6° C., respectively.

In contrast, the LED bulb 100 of the present invention which includes the heat dissipating plate 55 of 1 mm has heat conductivity equal to that of the conventional. LED bulb when the external average temperature of the housing 20 is 54.9° C., the maximum temperature of the housing 20 is 61.7° C., the average temperature of the surface of the heat dissipating plate 55 is 61.7° C., and the maximum temperature of the heat dissipating plate 55 is 61.9° C.

Thus, when comparing the LED bulb 100 having the housing 20 made of plastic and the heat dissipating plate 55 manufactured by insert injection with the conventional LED bulb, it can be seen that heat generated by the LED elements 40 is efficiently dissipated by the latter.

Further, there is a space in the housing 20 so that the inverter 70 can be inserted into the housing 20. The inverter 70 inserted into the housing 20 is coupled to the connector 45. The inverter 70 is a device that converts alternating current into direct current. The inverter 70 converts an alternating current, input from the socket 30 through electrode wires 70a, into a direct current, and supplies the direct current through the connector 45 to the LED module 50.

Here, the connector 45 and the inverter 70 are constructed to be coupled to each other in a one-touch-type coupling manner. Thus, after the connector 45 is placed to face the inverter 70, pressure acts on ends of the connector 45 and the inverter 70, so that the connector 45 is coupled to the inverter 70. Since the connector 45 passes through the LED module 50 and is fitted over the inverter 70, direct current can be supplied to the LED module 50. This is shown in FIG. 7.

As such, the present invention provides the LED bulb 100 which does not need the bottom case into which the inverter 70 is inserted, thus saving on resources including assembling processes, the labor used to assemble and manage, and material costs. Further, the connector 45 and the inverter 70 are coupled in a one-touch-type coupling manner, so that the connector 45 can be more easily coupled to the inverter 70.

According to the present invention, each heat dissipating protrusion 20a has a tapered shape, but is not limited to the tapered shape. That is, the heat dissipating protrusion 20a may have the shape of a streamlined wedge or a right-angled triangular wedge. As such, the shape of the heat dissipating protrusion 20a may be freely changed depending on the shape of the housing 200.

Further, according to the present invention, the heat dissipating protrusion 20a protrudes integrally from the outer circumferential surface of the housing 20, but is not limited to the shape. That is, after a plurality of heat dissipating protrusions 20a is separately manufactured, the heat dissipating protrusions 20a may be adhered to the outer circumferential surface of the housing 20.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An LED bulb using a thermal conductor, comprising:
an LED module having a PCB on which at least one LED element is mounted;
a housing having a plurality of heat dissipating protrusions which protrude from an outer circumferential surface thereof, and made of a thermal conductor, with a thread being formed on a predetermined portion of the housing;
a light transmitting cover having a thread by which the cover can be fastened to the thread which is formed on the predetermined portion of the housing, in a threaded manner;
an inverter supplying a direct current to the LED module;
a heat dissipating plate provided between the LED module and the housing to dissipate heat generated by the LED element, and integrated with the housing by insert injection when the housing is formed; and
a socket fastened to the housing.

2. The LED bulb as set forth in claim 1, wherein the heat dissipating plate further comprises:
a heat dissipating part provided on a lower portion of the heat dissipating plate which faces the housing, and having at least one of a wavy shape and an uneven shape.

3. The LED bulb as set forth in claim 2, wherein the heat dissipating plate is made of a material having heat conductivity.

4. The LED bulb as set forth in claim 1, further comprising:
a connector coupled to the inverter by a one-touch-type coupling manner.

5. The LED bulb as set forth in claim 1, wherein the plurality of heat dissipating protrusions are radially arranged on the outer circumferential surface of the housing in such a way as to protrude in a direction perpendicular to an axial direction of the housing.

6. The LED bulb as set forth in claim 5, wherein each of the heat dissipating protrusions is tapered such that an area thereof increases in a direction from a lower portion to an upper portion of the housing.

7. The LED bulb as set forth in claim 1, wherein the inverter is connected to the socket via an electrode wire, and converts an alternating current, input from an outside through the socket, into a direct current and then supplies the direct current to the LED module.

8. The LED bulb as set forth in claim 6, wherein the housing is formed using a thermal conductive resin including thermal conductive plastics.
